(19) United States
(12) Patent Application Publication
(10) Pub. No.: US 2026/0310467 A1
(43) Pub. Date: Oct. 8, 2026

(54) MULTIPLE INSTRUCTION MULTIPLE DATA PROCESSING UNIT

(71) Applicant: Abaxor Engineering GmbH, Magdeburg (DE)

(72) Inventor: Thomas Reinemann

(21) Appl. No.: 19/482,851

(22) PCT Filed: May 11, 2023
(86) PCT No.: PCT/EP2023/062654

§ 371 Date: Nov. 10, 2025

(51) Int. Cl. G06F 9/38; G06F 7/499; G06F 7/527; G06N 3/048

(52) U.S. Cl. CPC G06F 9/3889; G06F 7/4991; G06F 7/527; G06N 3/048

(57) ABSTRACT

A processing unit is provided, comprising: a plurality of modules, each configured to receive a first number of inputs and to compute an output, the plurality of modules being divided into N subsets of modules which are connected in series, wherein each subset of modules is configured to: process a respective total number of inputs received by the subset, and wherein each module of the subsets of modules is configured to: process the first number of inputs from the respective total number of inputs received by the subset of modules to compute the output of the module in parallel with the other modules of the subset of modules; and transfer the output of the module, in parallel with the other modules of the subset of modules, as an input to a respective subsequent subset of modules connected in series. The processing unit, which may be a MIMD processing unit, may further comprise an interface to receive inputs and weights and may further comprise an output subset to perform one or more activation functions on the received one or more outputs.

The present disclosure relates to computer architecture. Specifically, the present disclosure relates to multiple instruction multiple data (MIMD) computer architecture and to the design and implementation of MIMD processing units.

The demand of computing power is constantly increasing, especially due to the increased use of artificial intelligence and machine learning. Legacy processing units such as arithmetic logic units (ALUs) or multiply-accumulators (MACs) can apply only one operation to two operands during one processing step. This is referred to as Single-Instruction Single-Data (SISD) processing. More advanced units such as Graphics Processing Units (GPUs), Advanced Vector Extensions (AVXs), and Streaming SIMD Extensions (SSEs) can apply an operation to multiple operands at the same time during one processing step. This is referred to as Single-Instruction Multiple-Data (SIMD) processing. However, operations on the same operands are performed one after the other, i.e. sequentially. Accordingly, state of the art processing units are not able to apply multiple operations to multiple operands simultaneously during one processing step. In addition, existing processing units suffer from a number of drawbacks including structural complexity, limited scalability, long busses and increased number of caches.

Existing algorithms related to artificial neural networks, string comparisons, and Finite Impulse Response (FIR) filters, all perform the sum of weighted inputs operation. Some implementations of said algorithms use MAC cores in Field Programmable Gate Arrays (FPGAs). Other implementations, such as Google's Tensor Processing Unit (TPU), use a systolic array with MAC units including an activation unit on the nodes. Some other implementations of said algorithms use MACs in an Accumulated Matrix Product (AMP), such as the Intelligence Processing Unit (IPU) of Graphcore. By using a MAC, said implementations can only perform one loop pass to calculate one weighted input per clock cycle.

Analog compute-in-memory implementations of said algorithms also exist. For instance, Digital to Analog Converters (DACs) have been used by Mythic Al to convert neuron outputs into analog signals, which were amplified by tunable resistors and added. The resulting current is converted back to a digital signal by an Analog to Digital Converter (ADC). However, all these technologies have in common that the neuron outputs are exchanged via a bus, which becomes a bottleneck and limits performance. In addition, all these approaches do not take the data exchange within their architectures into account. That is why they don't scale.

A system was presented in US2017/0357891 that discloses one or more bit-serial tiles for performing bit-serial computations in which each bit-serial tile receives input neurons and synapses, and communicates output neurons. Also included is an activation memory for storing the neurons and a dispatcher and a reducer. The dispatcher reads neurons and synapses from memory and communicates them bit-serially to the one or more bit-serial tiles. The reducer receives the output neurons from the one or more tiles, and communicates the output neurons to the activation memory. However, this system suffers from increased complexity due to the fact that the sum of weighted inputs operations are done in a bit-parallel manner, and due to the utilization of the dispatcher, reducer, and activation memory.

The systems presented in US2019/0228307 and US2020/0371745 disclose data processing methods that include encoding a plurality of weights of a filter of an artificial neural network using an inverted two's complement fixed-point format to generate weight data, and performing an operation on the weight data and input activation data using a bit-serial scheme to control when to perform an activation function with respect to the weight data and input activation data. However, these systems suffer from increased complexity due to the fact that the sum of weighted inputs operations are done in a bit-parallel manner, and due to the utilization of input registers.

Hence, there is a need to enhance current processing architectures such that they become simple and scalable to enable, in particular, real-time MIMD processing. Further, it would be desirable that the enhanced processing architecture would allow fast computing without requiring a bus to transfer intermediate calculation results, or caches to store said results. It would also be desirable to provide an enhanced architecture enabling point to multipoint communication by routing, instead of addressing. Further, it would be desirable to provide an architecture that exhibits a constant time behavior, instead of a time behavior dependent on loop numbers, as is the case in conventional architectures. In addition, a real-time performance by design is desired, as opposed to a real-time performance bound to the operating system as in current architectures. In addition, it is desired to be able to fit, against the background of the same chip area, smaller IC structures by using more layers and more processing units per layer. This is not possible with current architectures, as more cores require longer busses and more caches.

According to an aspect of the present invention, there is provided a processing unit, comprising: a plurality of modules, each configured to receive a first number of inputs and to compute an output, the first number of inputs being greater to or equal to 2, the plurality of modules being divided into N subsets of modules, wherein the N subsets of modules are connected in series from a first subset to an Nth subset, wherein each subset of modules is configured to: process a respective total number of inputs received by the subset, and wherein each module of the subsets of modules is configured to: process the first number of inputs from the respective total number of inputs received by the subset of modules to compute the output of the module in parallel with the other modules of the subset of modules; and transfer the output of the module, in parallel with the other modules of the subset of modules, as an input to a respective subsequent subset of modules connected in series.

By having each module configured to receive a first number of inputs greater or equal to 2, and to compute one output, and by having N subsets of modules connected in series from a first subset to an Nth subset, a tree-like architecture is provided that simultaneously receives a total number of inputs by its first subset, and simultaneously generates one output by its Nth subset.

By configuring each module of the subsets of modules to process the first number of inputs to compute the output of the module in parallel with the other modules of the subset of modules, a simultaneous processing of all inputs, each of which may be an operand, is thereby enabled.

For instance, starting from the first subset of modules, during one clock cycle, one bit of each input of the first number of inputs of a module in a particular subset may be simultaneously processed (e.g. added) to compute the output (e.g. intermediate sum of the bits of the first number of inputs) in parallel with the others modules of the subset. Accordingly, all the inputs may be processed simultaneously by the modules in the particular subset to compute the outputs (e.g. intermediate sums of all input bits) during one clock cycle.

By transferring the output of the module, in parallel with the other modules of the subset of modules, as an input to a respective subsequent subset of modules connected in series, no caches are needed for storing the outputs (e.g. intermediate sums), and no bus is needed for transferring said outputs, thereby enabling a point to multipoint communication by routing, instead of addressing, and considerably reducing the architectural complexity of the processing unit.

According to aspects, the transferred outputs may be processed by the respective subsequent subsets to compute subsequent outputs (e.g. subsequent intermediate sums), until reaching the Nth subset of modules that computes the final output (e.g. the sum of all input bits). While the outputs are passed from the first subset of modules to be processed by the subsequent subset of modules connected in series, new inputs (e.g. next bits of operands) are simultaneously processed by the modules of the first subset of modules, thereby enabling a bit-serial processing of all inputs simultaneously, and allowing a real-time MIMD processing.

According to aspects, the first subset may comprise a first number of modules equal to a respective total number of inputs received by the first subset divided by the first number of inputs, the respective total number of inputs received by a subset may be an integer multiple of the first number of inputs.

According to aspects, each respective subsequent subset of modules may comprise a number of modules equal to a number of outputs computed by a subset of modules preceding the subsequent subset of modules divided by the first number of inputs. Accordingly, the total number of modules in the N subsets may be equal to the total number of inputs received by the first subset minus one. The modules of the subsets of modules may be configured to transfer the output bit-serially and least significant bit, LSB-first as an input to a corresponding module of the respective subsequent subset of modules. This eliminates the need to have caches for storing the outputs, and eliminates the need to have a bus to transfer said outputs, considerably reducing the architectural complexity.

Accordingly, by simultaneously receiving all inputs or operands LSB-first, by simultaneously processing the bits of all the received inputs LSB-first to generate respective outputs, and by simultaneously transferring the generated respective outputs as inputs to respective subsequent modules connected in series while simultaneously processing new bits of all the received inputs to generate new respective outputs, the proposed bit-serial architecture, unlike existing bit-parallel architectures, enables the distributed processing of all inputs or operands simultaneously, which compensates for the additional number of clock cycles needed. Existing bit-parallel architectures are not able to process all inputs or operands simultaneously. These architectures are limited to process two inputs or operands simultaneously during one clock cycle.

According to aspects, the processing unit may further comprise an interface subset of modules configured to receive a respective total number of inputs and a corresponding number of weights equal to the respective total number of inputs, and to compute weighted outputs. The respective total number of inputs may be bit-serially received from a respective total number of processing units or from a respective total number of parallel to serial converters. The respective total number of inputs may be synchronized by one or more input synchronization signals received from the respective total number of processing units or from a respective total number of parallel to serial converters. The weights may be provided by a control logic.

According to aspects, the interface subset of modules may comprise a number of modules equal to the respective total number of inputs received by the interface subset of modules. Each module of the interface module may be configured to receive a respective input of the respective total number of inputs and a corresponding weight of the corresponding weights, and to compute an output. Each module of the interface subset of modules may be configured to transfer the weighted output bit-serially and LSB-first to a corresponding module of the first subset of modules as an input. The interface subset may be configured to receive the respective total number of inputs bit-serially and LSB-first, and to receive the number of corresponding weights in a bit-parallel format, or bit-serially and LSB-first.

According to aspects, the processing unit may further comprise an output subset of modules that may be configured to receive one or more outputs of the subsets of modules and to perform one or more operations on the received one or more outputs to compute an output of the processing unit. The one or more operations may comprise applying to the received output one or more activation functions. The one or more activation functions may comprise binary step, linear, sigmoid, tanh, rectified linear unit, ReLu, leaky ReLU, parameterised ReLU, exponential linear unit, Swish, unit sample, carry, one, modulo, 1/n, and Softmax function. The activation functions may be configured to be implemented using fixed look up tables (LUTs) and/or programmable (LUTs). The processing unit may further comprise a control logic. The control logic may be configured to select one of the fixed LUTs or programmable LUTs. The processing unit may be an MIMD processing unit.

According to another aspect of the present invention, there is provided a processing method comprising: receiving, by each subset of a plurality of modules comprised in a processing unit, a respective total number of inputs, wherein the processing unit comprises a plurality of modules divided into N subsets of modules, wherein the subsets of modules are connected in series from a first subset to an Nth subset, wherein each module is configured to receive a first number of inputs and to compute an output, and wherein the first number of inputs is greater to or equal to 2; and processing, by each subset of modules comprised in the processing unit, the respective total number of inputs received by each subset, wherein each module of the subset of modules processes the first number of inputs from the respective total number of inputs received by the subset of modules to compute the output of the module in parallel with the other modules of the subset of modules, and wherein the output of the module is transferred, in parallel with the other modules of the subset of modules, as an input to the respective subsequent subset of modules connected in series.

The first subset may comprise a first number of modules equal to a respective total number of inputs received by the first subset divided by the first number of inputs, wherein the respective total number of inputs received by a subset may be a multiple of the first number of inputs. Each subsequent subset of modules may comprise a subsequent number of modules equal to a number of outputs computed by a preceding subset of modules divided by the first number of inputs.

The method may further comprise transferring, by each module of the subsets of modules, the output bit-serially and LSB-first as an input to a corresponding module of the respective subsequent subset of modules. Processing, by each subset of modules comprised in the processing unit, the respective total number of inputs received by each subset, may comprise bit-serial and LSB-first processing of the respective total number of inputs, or partial bit-serial and LSB-first processing of the respective total number of inputs. The processing unit may be an MIMD processing unit. The processing unit may be configured to perform discontinuous processing in a processing network.

The following detailed description and accompanying drawings provide a more detailed understanding of the nature and advantages of the present invention.

### BRIEF DESCRIPTION OF THE FIGURES

The accompanying drawings are incorporated into and form a part of the specification for the purpose of explaining the principles of the embodiments. The drawings are not to be construed as limiting the embodiments to only the illustrated and described embodiments of how they can be made and used. Further features and advantages will become apparent from the following and more particularly from the description of the embodiments, as illustrated in the accompanying drawings, wherein:

FIG. 1 illustrates a processing unit according to an embodiment;

FIG. 2 illustrates a processing unit according to an embodiment;

FIG. 3 illustrates a processing unit comprising an interface subset of modules and an output subset of modules, according to embodiments;

FIG. 4 illustrates a synchronization example of a processing unit, according to embodiments;

FIG. 5 illustrates a module with a carry clear logic according to an embodiment;

FIG. 6 illustrates a processing unit showing the synchronization signals flow, according to embodiments.

FIG. 7 illustrates a combination of processing units implementing a processing network according to an embodiment;

FIG. 8 is a flow diagram illustrating a method for processing inputs received by a processing unit, according to an embodiment.

FIG. 9 is a flow diagram illustrating a method for processing inputs received by a combination of processing units implementing a processing network, according to an embodiment.

### DETAILED DESCRIPTION

Described herein are systems and methods for the design and implementation of MIMD processing units. For purposes of explanation, numerous examples and specific details are set forth in order to provide a thorough understanding of the described embodiments. Embodiments as defined by the claims may include some or all of the features in these examples alone or in combination with other features described below, and may further include modifications and equivalents of the features and concepts described herein. The illustrative embodiments will be described with reference to the drawings wherein elements and structures are indicated by reference numbers. Further, where an embodiment is a method, steps and elements of the method may be combinable in parallel or sequential execution. As far as they are not contradictory, all embodiments described below can be combined with each other.

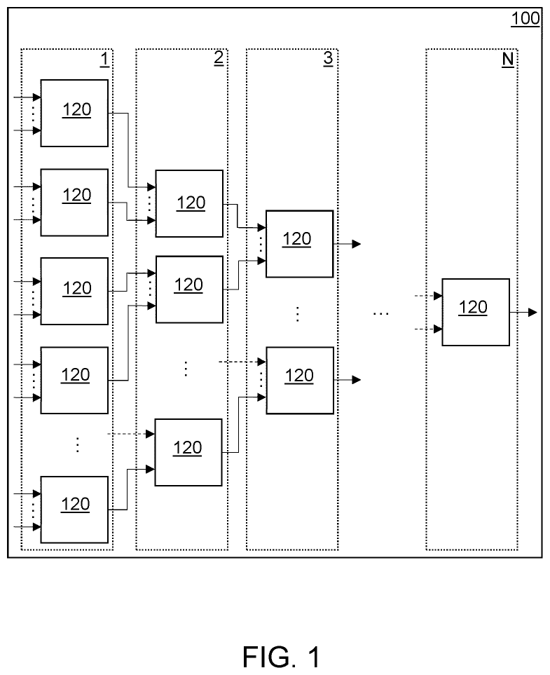

FIG. 1 illustrates a processing unit 100 according to an embodiment. The processing unit, comprises a plurality of modules 120. Each module 120 is configured to receive a first number of inputs and to compute an output. The first number of inputs is greater to or equal to 2. The plurality of modules are divided into N subsets of modules 1, 2, 3, . . . , N. The N subsets of modules are connected in series from a first subset to an Nth subset. Each subset of modules is configured to process a respective total number of inputs received by the subset. Each module of the subsets of modules is configured to process the first number of inputs from the respective total number of inputs received by the subset of modules to compute the output of the module in parallel with the other modules of the subset of modules. Each module of the subset of modules is further configured to transfer the output of the module, in parallel with the other modules of the subset of modules, as an input to a respective subsequent subset of modules connected in series. Processing, by each module, the first number of inputs from the respective total number of inputs received by the subset of modules may comprises simultaneously processing, by each module, a bit of each input of the first number of inputs to compute the output of the module. Each input of the first number of inputs may be represented using M bits.

The first subset may comprise a first number of modules equal to a respective total number of inputs received by the first subset divided by the first number of inputs, the respective total number of inputs received by a subset may be an integer multiple of the first number of inputs. Each respective subsequent subset of modules may comprise a number of modules equal to a number of outputs computed by a subset of modules preceding the subsequent subset of modules divided by the first number of inputs. The modules of the subsets of modules may be configured to transfer the output bit-serially and least significant bit, LSB,-first as an input to a corresponding module of the respective subsequent subset of modules. Computing, by each module of a subset of modules, the output of the module in parallel with the other modules of the subset of modules, comprises computing, by each module of a subset of modules, the output of the module simultaneously with the other modules of the subset of modules. Transferring the output of the module, in parallel with the other modules of the subset of modules, as an input to a respective subsequent subset of modules connected in series, comprises transferring the output of the module, simultaneously with the other modules of the subset of modules, as an input to a respective subsequent subset of modules connected in series.

The respective subsequent subset of modules connected in series may be an immediate subsequent set of modules connected in series. Each input of the respective total number of inputs received by a subset may be an operand. Each input of the respective total number of inputs received by a subset may be represented using M bits. Each input of the respective total number of inputs received by a subset may be represented in a two's complement form.

The respective total number of inputs of a subset may be equally divided among the modules of the subset of modules, such that the sum of all first numbers of inputs in the subset is equal to the respective total number of inputs of the subset. Each subset of modules may be further configured to process the respective total number of inputs bit-serially and LSB-first, or partially bit-serial and LSB-first. Processing, by a subset of modules the respective total number of inputs bit-serially and LSB-first, may comprise processing, by each module of the subset of modules, the first number of inputs bit-serially and LSB-first. Processing, by a subset of modules the respective total number of inputs partially bit-serially and LSB-first, may comprise performing, by each module of the subset of modules, a serial to parallel conversion of each input of the first number of inputs to generate converted first number of inputs having a bit-parallel format, performing a bit-parallel processing on the converted first number of inputs to compute a bit-parallel processing result, and performing a parallel to serial conversion on the bit-parallel processing result to generate the output of the module.

Each module of the subsets of modules may comprise one or more arithmetic and logical circuits, wherein the arithmetic and logical circuits comprise at least one of an adder, a subtractor, a multiplier, an AND, an OR, a NAND, a NOR, a NOT, and an XOR. Each module of the subsets of modules is configured to process the first number of inputs by performing, using the one or more arithmetic and logical circuits of the module, one or more operations on the first number of inputs to compute the output.

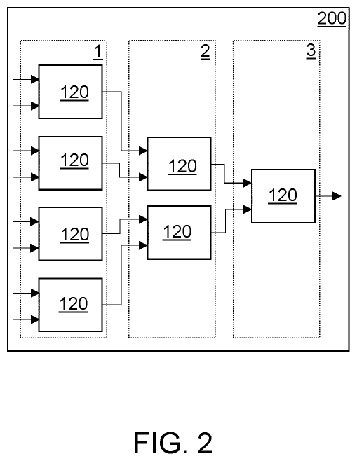

FIG. 2 illustrates a processing unit 200 according to an embodiment. According to this embodiment, the processing unit 200 is an example of the processing unit 100 illustrated in FIG. 1. According to this embodiment, the first number of inputs received by each module 120 is two. The plurality of modules are divided into N subsets of modules, wherein N is equal to three. The three subsets of modules 1, 2 and 3 are connected in series from the first subset to a third subset. The respective total number of inputs received by the first subset is eight. The total number of modules in the three subsets of modules is seven.

Each subset of modules is configured to process the respective total number of inputs received by the subset. In this embodiment, the total number of inputs processed by the first subset is eight, the total number of inputs processed by the second subset is four, and the total number of inputs processed by the third subset is two.

Each module of the subsets of modules is configured to process the first number of inputs, which is two in this embodiment, from the respective total number of inputs received by the subset of modules to compute the output of the module in parallel with the other modules of the subset of modules; and transfer the output of the module, in parallel with the other modules of the subset of modules, as an input to a respective subsequent subset of modules connected in series.

Each input of the respective total number of inputs received by the subset of modules may be an operand represented using M bits. For instance, starting from the first subset of modules, during one clock cycle, one bit of each input of the two inputs of a module in a particular subset may be simultaneously processed (e.g. added) to compute the output (e.g. intermediate sum of the two input bits of the two operands) in parallel with the others modules of the subset. Accordingly, all the inputs may be processed simultaneously by the modules in the particular subset to compute the outputs (e.g. intermediate sums of all input bits) during one clock cycle.

The transferred outputs are processed by the second subsequent subset of module to compute two subsequent outputs (e.g. subsequent intermediate sums). The two subsequent outputs are transferred to be processed by the third subset of modules that computes the final output (e.g. the sum of all eight input bits of the eight operands).

While the outputs are transferred from the first subset of modules to be processed by the subsequent subset of modules connected in series, subsequent inputs (in this embodiment, the next eight input bits of the eight operands) are simultaneously processed by the modules of the first subset of modules. Once all M bits of all inputs are processed by the first subset of modules, a respective total number of new inputs (in this embodiment, a respective total number of new operands) may be received to be processed by the first subset of modules.

According to aspects, the modules of the subsets of modules may be configured to transfer the output bit-serially and least significant bit, LSB,-first as an input to a corresponding module of the respective subsequent subset of modules. Computing, by each module of a subset of modules, the output of the module in parallel with the other modules of the subset of modules, comprises computing, by each module of a subset of modules, the output of the module simultaneously with the other modules of the subset of modules. Transferring the output of the module, in parallel with the other modules of the subset of modules, as an input to a respective subsequent subset of modules connected in series, comprises transferring the output of the module, simultaneously with the other modules of the subset of modules, as an input to a respective subsequent subset of modules connected in series. The respective subsequent subset of modules connected in series may be an immediate subsequent set of modules connected in series. Each input of the respective total number of inputs received by a subset of modules may be represented in a two's complement form. The processing unit may be an MIMD processing unit.

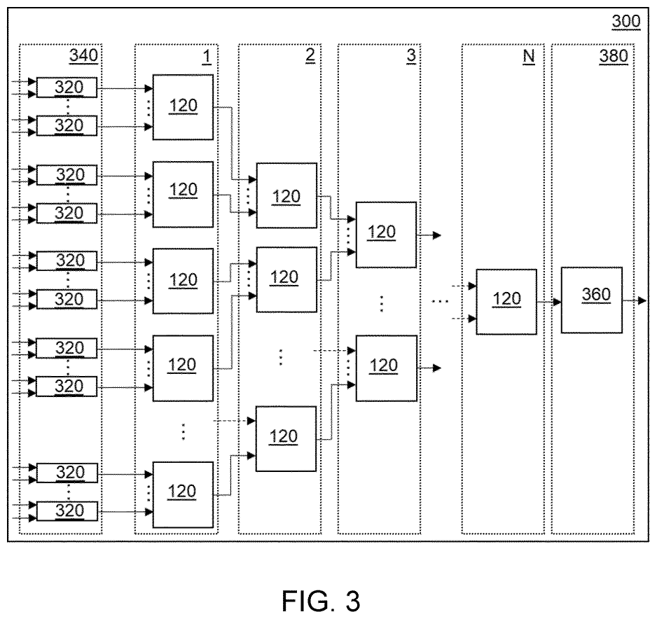

FIG. 3 illustrates a processing unit 300 comprising an interface subset 340 of modules 320 and an output subset 380 of modules 360, according to embodiments. The processing unit 300 may further comprise an interface subset 340 of modules 320 configured to receive a respective total number of inputs and a corresponding number of weights equal to the respective total number of inputs, and to compute weighted outputs.

The respective total number of inputs received by the interface subset of modules of a processing unit may correspond to the outputs of a respective total number of processing units. The respective total number of inputs received by the interface subset 340 of modules 320 of a processing unit 300 may be the outputs of a respective total number of processing units comprised in a preceding layer of a processing network. The respective total number of inputs received by the interface subset of modules of a processing unit may be the outputs of a respective total number of parallel to series converters 720. The corresponding number of weights may be provided by a control logic 620. The control logic 620 may be comprised in the processing unit.

The respective total number of inputs received by the interface subset of modules may be synchronized by input synchronization signals. The input synchronization signals may be received from a respective total number of processing units 300 comprised in a preceding layer of a processing network or from a respective total number of parallel to series converters 720, or from a bus.

Each input of the respective total number of inputs received by the interface subset 340 of modules 320 may be an operand represented using M bits. Each weight of the corresponding total number of weights received by the interface subset of modules may be an operand represented using M bits.

The interface subset 340 may comprise a number of modules 320 equal to the respective total number of inputs received by the interface subset of modules. Each module 320 of the interface subset 340 may be configured to receive a respective input of the respective total number of inputs and a corresponding weight of the corresponding number of weights, and to compute an output.

The interface subset 340 of modules 320 may be further configured to receive the respective total number of inputs bit-serially and LSB-first, and to receive the number of corresponding weights in a bit-parallel format, or bit-serially and LSB-first. When the number of corresponding weights is received in a bit-parallel format, a parallel to serial converter may be used to convert the bit-parallel format into a bit-serial format. Each module of the interface subset of modules may be configured to transfer the weighted output bit-serially and LSB-first to a corresponding module of the respective subsequent subset of module as an input. The respective subsequent subset of module may be the first subset 1 of modules 120.

Each module 320 of the interface subset 340 of modules may be further configured to, simultaneously with the other modules of the interface subset, perform a bit-serial multiplication operation of an input from the respective total number of inputs with a corresponding weight from the number of corresponding weights, to compute the weighted output. Accordingly, since the logic required for a bit-serial multiplier is much smaller than for a bit-parallel multiplier, all the necessary multipliers can be implemented on the same chip of the processing unit, thereby enabling a faster processing of all inputs in parallel.

The processing unit may further comprise an output subset 380 of modules 360, as illustrated in FIG. 3. The output subset of modules may be configured to receive one or more outputs of the subsets of modules and to process the received one or more outputs. The output subset 380 of modules may comprise one module 360. The output module may be configured to receive the output of the Nth subset N of modules and to process the received output. Processing the received output of the Nth subset of modules may comprise a bit-serial processing of the received output, or a partial bit-serial and LSB-first processing of the received output. The partial bit-serial and LSB-first processing of the received output may comprise performing a serial to parallel conversion on the received output to generate a converted output having a parallel-format. The partial bit-serial and LSB-first processing of the received output may further comprise performing one or more operations on the converted output to compute a result, and performing a parallel to serial conversion on the result to generate the output of the output module.

The one or more operations may comprise applying to the converted one or more outputs one or more activation functions. The one or more activation functions may comprise binary step, linear, sigmoid, tanh, rectified linear unit, ReLu, leaky ReLU, parameterised ReLU, exponential linear unit, Swish, unit impulse, carry, one, modulo, 1/n, and Softmax function.

The one or more activation functions may be implemented using fixed look up tables (LUTs) and/or programmable (LUTs). A control logic (620), comprised in the processing unit, may be configured to select one of the fixed LUTs or programmable LUTs to be applied to the converted one or more outputs to compute a result.

According to any of the above-mentioned embodiments, each module 340 and 120 of the subset 340, 1, 2, 3, . . . , N of modules may be further configured to transfer, simultaneously with the other modules of the subset of modules, a start bit, to the corresponding module of the respective subsequent subset 1, 2, 3, . . . , N, 380 of modules. The start bits may be simultaneously transferred to the corresponding modules in a first time interval preceding a second time interval. The second time interval may be the time interval in which the least significant bits, LSBs, of the respective total number of inputs are simultaneously transferred to be processed by the corresponding modules of the respective subsequent of a subset of modules. The start bits indicate the processing start of the respective total number of inputs by a subset of modules. Each input of the respective total number of inputs received by a subset of modules may be represented using M bits. A time interval may comprise one or more clock cycles.

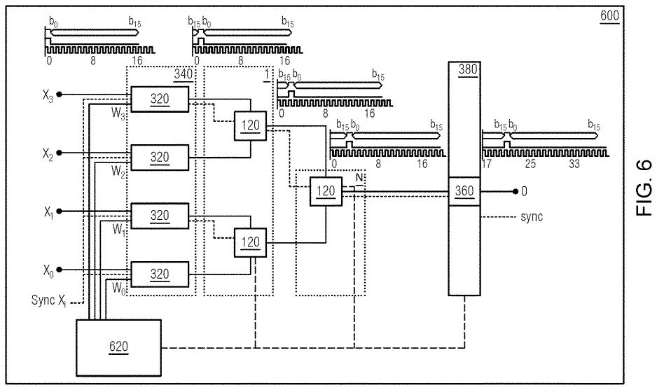

According to any one of the above-mentioned embodiments, each subset 340, 1, 2, 3, . . . , N, 380 of modules, may be further configured to transfer an input synchronization signal to a respective subsequent subset of modules to identify the first time interval in which the start bits are simultaneously transferred to the corresponding modules of the respective subsequent subset of modules. The input synchronization signal of the interface subset of modules may be received from the output subset of modules of a preceding or another processing unit, or from a bus. The simultaneously transferred start bits may be active or ON in the first time interval while the input synchronization signal is active or ON, such that an overflow or a carry within the subset of modules is cleared. The input synchronization signal may be deactivated or OFF after the first time interval. This shortens the chain for the carry, and reduces both the logic effort and the routing effort. This also enables higher clock frequencies. A logic circuit that implements this overflow or carry clear logic is described below with reference to FIG. 5.

Each subset of modules, according to any one of the above-mentioned embodiments, may be configured to synchronize the outputs of the subset of modules based on an output synchronization signal. The output synchronization signal may be active in a third time interval subsequent to the second time interval. The second time interval may be the time interval in which an LSB, of the respective total number of inputs is processed by the modules of a subset of modules, as mentioned above. The time at which the third time interval starts is a function of the time taken by a subset 340, 1, 2, 3, . . . , N, 380 of modules to process the respective total number of inputs. The time taken by the interface subset of modules to process the respective total number of inputs may correspond to an integer number of clock cycles. The time taken by the interface subset 340 of modules to process the respective total number of inputs may be different than the time taken by any of the first to Nth subset 1, 2, 3, . . . , N of modules to process the respective total number of inputs. The time taken by the output subset 380 of modules to process the one or more outputs of the subset of modules may be different than the time taken by the other subsets of modules in the processing units.

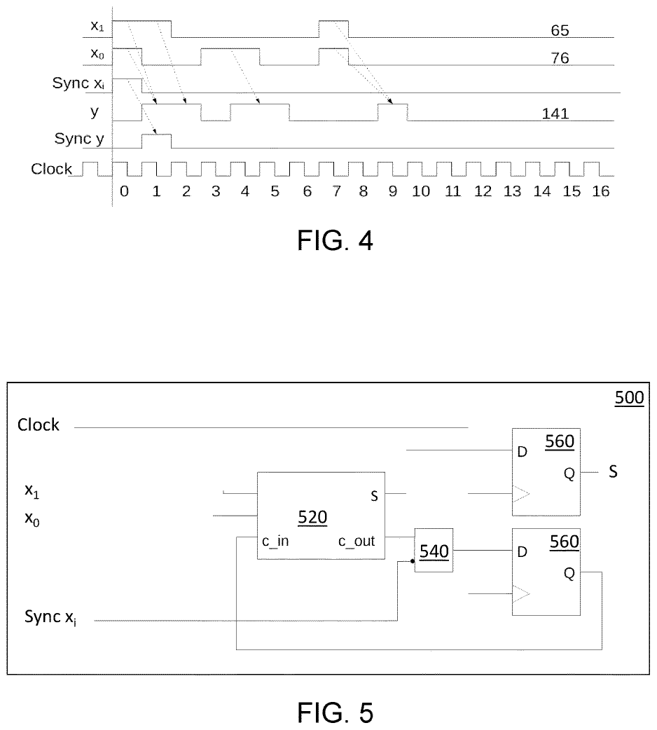

According to any of the above embodiments, each module 120 of the first to Nth subset of modules, may be further configured to process the first number of inputs by performing one or more operations on the first number of inputs. The one or more operations may comprise: simultaneously receiving, during the second time interval (following the first time interval in which the start bits are received), a bit of each input of the first number of inputs, starting with the LSB. The one or more operations may further comprise performing, in the third time interval subsequent to the second time interval mentioned above, an addition operation on the received bits to compute the output, and simultaneously receiving, in the third time interval subsequent to the second time interval, a subsequent bit of each input of the first number of inputs. If the addition operation generates a carry, the carry is added, in a fourth time interval subsequent to the third time interval, to the bits received in the fourth time interval to compute the output. If the bits received in a particular time interval are the start bits and the input synchronization signal is active or ON during the particular time interval, the carry is cleared using a carry clear logic. The carry clear logic may be implemented as described with reference to FIGS. 4 and 5.

Each subset of modules according to any one of the above-mentioned embodiments, may be configured to synchronize the outputs of the subset of modules based on an output synchronization signal, wherein the output synchronization signal is active in the third time interval subsequent to the second time interval mentioned above. Wherein the time at which the third time interval starts is a function of the time taken by a subset of modules to process the respective total number of inputs. The time taken by the interface subset of modules to process the respective total number of inputs and compute the weighted outputs may be different from the time taken by the other subset of modules in the processing unit. Similarly, the time taken by the output subset of modules to process the one or more outputs of the subset of modules and compute the processing unit output may be different from the time taken by the other subsets in the processing unit. This is because the output subset of module may deploy a series to parallel converter to convert the received one or more outputs into a parallel format, and to apply, based on the converted one or more outputs, one or more activation functions as mentioned above, to generate a result, and to convert the generated result back into a bit-serial format using a parallel to series conversion.

The output subset 380 of modules 360 of the processing unit 300 may be configured to synchronize its output, using an input synchronization signal, with one or more respective input of one or more respective interface modules 340 associated with one or more subsequent processing units 300. Alternatively, the input synchronization signal may be transferred from a bus to the one or more respective interface modules 340 associated with the one or more subsequent processing units 300. The output of the output subset of modules may be transferred bit-serially and LSB-first as an input to of one or more respective interface modules 340 associated with one or more subsequent processing units 300. The one or more subsequent processing units may be comprised in a subsequent layer of a computing network. The processing unit may be an MIMD processing unit. Each processing unit may be configured to perform discontinuous processing in a processing network. The processing unit may be implement using application-specific integrated circuit, ASICs. These ASICs may replace FPGAs, CPUs as well as GPUs.

FIG. 4 illustrates a synchronization example of a module 120 of any subset of the first to Nth subset of modules, according to embodiments. In this example, the binary representation of numbers is used. The first number of inputs received by any module is two. The inputs are illustrated by x₀ and x₁ in FIG. 4. Each input may be an operand. Each input is represented using M bits. The M bits are processed LSB-first.

An input synchronization signal, shown in FIG. 4 as Sync xᵢ, may be transferred from a respective preceding subset of modules, or from a control logic, to identify the first time interval in which the start bits are simultaneously transferred to the corresponding modules of the respective subsequent subset of modules, comprising the module that processes the shown inputs x₀ and x₁. This first time interval is shown in FIG. 4 as the time interval corresponding to clock cycle 0. The simultaneously transferred start bits are active or ON in the first time interval while the input synchronization signal is active or ON, such that an overflow or carry within the subset of modules is cleared. This shortens the chain for the carry, and reduces both the logic effort and the routing effort. The logic circuit implementing this carry clear logic is shown in FIG. 5.

According to aspects, each module of the subset of modules may be configured to process the first number of inputs by performing one or more operations on the first number of inputs, the one or more operations may comprise: simultaneously receiving, in a second time interval (corresponding to clock cycle 1 of FIG. 4), a bit of each input of the first number of inputs, starting with the LSB.

The one or more operations may further comprise: performing, in a third time interval (corresponding to clock cycle 2 of FIG. 4) subsequent to the second time interval, an addition operation on the received bits to compute the output, and simultaneously receiving, in the third time interval subsequent to the second time interval, a subsequent bit of each input of the first number of inputs.

The one or more operations may further comprise: determining if the addition operation generates a carry, and if the additional operation generates a carry, adding the carry, in a fourth time interval (e.g. corresponding to clock cycle 3 of FIG. 4) subsequent to the third time interval, to the bits received in the fourth time interval to compute the output. This processing continues in a similar fashion during the next time intervals (clock cycles 4 to 16), until new start bits and input synchronization signal xᵢ are received by a module. When new start bits and input synchronization signal Sync xᵢ are received by a module, the above mentioned one or more operations are repeated. When new start bits and input synchronization signal Sync xᵢ are received by a module, any carry or overflow remaining in the module is cleared as explained above. This shortens the chain for the carry, and reduces both the logic effort and the routing effort.

Accordingly, by simultaneously receiving, by the interface subset, all the respective total number of inputs or operands LSB-first, by simultaneously processing (multiplying with corresponding weights) the bits of all the respective total number of inputs LSB-first to compute weighted outputs, and by simultaneously transferring the weighted outputs as inputs to be processed (simultaneously added) by respective subsequent modules connected in series while simultaneously receiving and processing new bits of all the respective total number inputs to compute new weighted outputs, the proposed bit-serial architecture, unlike existing bit-parallel architectures, enables the distributed processing of all inputs or operands simultaneously in multiplication and addition, which compensates for the additional number of clock cycles needed. Existing bit-parallel architectures are not able to process all inputs or operands simultaneously. These architectures are limited to processing only two inputs or operands simultaneously during one clock cycle. In bit-parallel architectures, the bits belonging to two operands are processed in one clock cycle. The carry transfer's duration determines the maximum clock frequency. In the proposed bit-serial processing, M bits belonging to the same input or operand are transferred in M clock cycles, while processing is distributed and is done simultaneously in multiplication and addition, and already starts when the LSB of the input or operand is received. The input or operand's start is marked by an additional start bit in front of the LSB, wherein the start bit is active while the input synchronization signal is active. This shortens the chain for the carry and reduces both the logic effort and the routing effort while also allowing for higher clock frequencies. All of this compensates for the additional number of clock cycles needed to process all the M bits of the inputs of operands.

FIG. 5 illustrates a module with a carry clear logic according to an embodiment. Any module 120 of the first to Nth subset 1, 2, 3, . . . , N of modules according to any of the above-mentioned embodiments mentioned above, may comprise a carry clear logic and may be implemented as described with reference to FIG. 5. In this embodiment, the first number of inputs received by the module is two. This is shown by the two inputs x₀ and x₁ of FIG. 5. The module may comprise a full adder 520, an AND gate 540 and two D flip-flops. The module may be configured to process the two inputs by performing one or more operations. The one or more operations may comprise: simultaneously receiving, by the full adder 520 a bit of each input of the two inputs, starting with the LSB, and performing, by the full adder 520, an addition operation on the received bits to compute the sum. If the addition operation generates a carry c_out, the carry is added by the full adder in a subsequent addition operation to the subsequently received bits.

As shown in FIG. 5, the output sum S of the full adder is the input of the D flip-flop 560. The output Q of the D flip-flop is the output of the module. The output carry c_out constitutes an input of the logic circuit 540. The synchronization signal Sync xᵢ is first inverted using a NOT gate and then inputted to the logic circuit 540. The logic circuit 540 may be an AND gate. The output of the logic circuit 540 is the input D of a D flip-flop 560. The output Q of the D flip-flop is fed to the carry input c_in of the full adder. When the output carry is active or ON and the synchronization signal is not active or OFF, the output generated by the logic circuit 540 is active or ON. This output of the logic circuit is inputted to the D flip-flop 560. Accordingly, the output Q of the D flip-flop, corresponding to the carry, will be active or ON, thereby feeding the carry to the carry input c_in of the full adder to be added to the bit received during the next time interval. The next time interval may be the subsequent clock cycle.

When the output carry is active or ON and the synchronization signal Sync xᵢ is also active or ON (thereby indicating that one of the two received inputs x₀ or x₁ are start bits), the output generated by the logic circuit 540 is de-activated or OFF. This output of the logic circuit is inputted to the D flip-flop 560. Accordingly, the output Q of the D flip-flop will be de-activated or OFF, thereby clearing out any overflow or carry present in the module. This shortens the chain for the carry, reduces both the logic effort and the routing effort, and allows for higher clock frequencies.

FIG. 6 illustrates a processing unit showing the synchronization signals flow according to embodiments. The above-mentioned embodiment described with reference to FIG. 3 may be implemented as described with reference to FIG. 6. A processing unit 600 comprising an interface subset 340 of modules 320, two subsets of modules 1 and 2, an output subset 380 comprising one module 360, and a control logic 620 are illustrated in FIG. 6 along with the synchronization signals flow into and from the different subsets. The interface subset 340 comprises four modules 320 configured to receive a respective total number of four inputs (X₀, X₁, X₂, X₃), and a corresponding number of weights (W₀, W₁, W₂, W₃) equal to the respective total number of inputs, and to compute weighted outputs.

The four inputs received by the interface subset of modules of the processing unit 600 may be the outputs of four processing units comprised in a preceding layer of a computing network, or may be the outputs of four parallel to series converters 720. The corresponding number of weights (W₀, W₁, W₂, W₃) are provided by the control logic 620.

The respective total number of inputs received by the interface subset of modules may be synchronized by input synchronization signals Sync xᵢ. The input synchronization signals are illustrated in the graph shown above each subset of modules. In this graph, the lower signal represents the clock signal, the intermediate signal represents the input synchronization signal Sync xᵢ, and the upper signal represents an input represented using 16 bits. Also shown in the upper signal is an additional bit (a start bit) preceding the LSB bit b₀ of the input. Each input may be an operand. Each input of the four inputs (X₀, X₁, X₂, X₃) is represented using 16 bits. Each weight of the four weights (W₀, W₁, W₂, W₃) is represented using 16 bits.

The input synchronization signals for the interface subset 340 of modules may be received from a respective total number of processing units 300 comprised in a preceding layer of a processing network as shown for the interface subset 340 or from a respective total number of parallel to series converters 720 or from a bus. The input synchronization signals for the first to Nth subsets of modules, and for the output subset of modules, may be received from a preceding subset of modules or from the control logic, as illustrated in FIG. 6.

The interface subset 340 of modules 320 may be configured to receive the four inputs (X₀, X₁, X₂, X₃) bit-serially and LSB-first, and to receive the four corresponding weights (W₀, W₁, W₂, W₃) in a bit-parallel format, or bit-serially and LSB-first. When the four corresponding weights are received in a bit-parallel format, a parallel to serial converter may be used to convert the bit-parallel format into a bit-serial format. Each module 320 of the interface subset of modules may be configured to transfer the weighted output bit-serially and LSB-first to a corresponding module of the respective subsequent subset of module as an input. The respective subsequent subset of module is the first subset 1 of modules.

Each module 320 of the four modules of the interface subset 340 of modules may be further configured to, simultaneously with the other modules of the interface subset, perform a bit-serial multiplication operation of an input bit from the four inputs (X₀, X₁, X₂, X₃) with a corresponding weight from the four corresponding weights (W₀, W₁, W₂, W₃), starting with the LSB, to compute the weighted output. The weighted outputs are transferred to the subsequent subset of modules while new input bits from the four inputs are received and processed by the interface subset. The weighted outputs are received and added by the modules 120 of the subsequent subset of modules.

According to aspects, the processing unit 600 may comprise an output subset 380 of modules 360 configured to receive the output of the Nth subset, wherein N is equal to 2, and to process the received output. Processing the received output of the Nth or second subset of modules comprises a bit-serial and LSB-first processing or a partial bit-serial and LSB-first processing of the received output. The partial bit-serial and LSB-first processing of the received output may comprise performing a serial to parallel conversion on the received output to generate a converted output having a parallel-format. The partial bit-serial and LSB-first processing of the received output may further comprise performing one or more operations on the converted output to compute a result, and performing a parallel to serial conversion on the result to generate the output of the output subset of modules, which is the output of the processing unit. The one or more operations performed on the converted output may comprise applying to the converted output one or more activation functions as described above.

The time taken by the output subset of modules to process the output of the second subset of modules and compute the processing unit output comprises the time needed to convert the received output to generate a converted output having a parallel format, the time needed to apply on the converted output one or more activation functions to generate a result, as described above, and the time needed to convert the generated result back into a bit-serial format using a parallel to series converter.

As illustrated in FIG. 6, the time needed by the output subset of modules to process the 16 bits input is 18 clock cycles, as shown in the graph above the output O of the output subset compared to the graph above the Nth or second subset of modules. The output subset of modules, according to any one of the above-mentioned embodiments, may be configured to accommodate longer or shorter delays, depending on the implementation or application. However, within one implementation, the delay is always kept constant.

As shown in FIG. 6, each module 340 and 120 of the subset 340, 1 and 2 of modules may be further configured to transfer, simultaneously with the other modules of the subset of modules, a start bit, to the corresponding module of the respective subsequent subset 1, 2 and 380 of modules. The start bits may be simultaneously transferred to the corresponding modules in a first time interval preceding a second time interval. The second time interval is the time interval in which the least significant bits, LSBs, of the respective total number of inputs are simultaneously transferred to the corresponding modules of the respective subsequent subset of modules. Each of the respective total number of inputs may be represented using M bits, not including the start bit. The start bit is an additional bit that indicates the processing start of the respective total number of inputs by a subset of modules. A time interval may comprise one or more clock cycles.

According to any one of the above-mentioned embodiments, it is not necessary that an input or operand of a subset of modules is immediately followed by another input or operand based on the input synchronization signal. In other words, the input synchronization signal may be transferred to and/or received by a subset of modules immediately after a number of clock cycles equals to the number of bits representing an input or operand. In FIG. 6 this number of clock cycles is 17. Alternatively, the input synchronization signal may also be transferred to and/or received by a subset of modules after a larger number of clock cycles (larger than the number of bits representing an input), or can be stopped or not transferred, thereby allowing discontinuous processing. This is an essential feature in the digital signal processing design of processing units.

Each subset of modules may be configured to synchronize the outputs of the subset of modules based on an output synchronization signal, as described above. Each module 120 of subset of modules 1, 2 shown in FIG. 6, may be configured to process the first number (two) of inputs by performing one or more operations on the first number (two) of inputs, as described above.

According to any one of the above-mentioned embodiments, each subset 340, 1 and 2 of modules, may be further configured to transfer an input synchronization signal to the respective subsequent subset of modules to identify the first time interval in which the start bits are simultaneously transferred to the corresponding modules of the respective subsequent subset of modules. The input synchronization signal of the interface subset of modules may be transferred from the output subset of module of a preceding processing unit or from a bus.

The output subset 380 of modules 360 according to any of the above-mentioned embodiments, may be configured to synchronize its output O, using an input synchronization signal sync, with one or more respective inputs of one or more respective interface subsets of modules 340 associated with one or more subsequent processing units 300, wherein the input synchronisation signal sync of the output subset of modules becomes the input synchronisation signal Sync xᵢ of the one or more respective interface subsets of modules 340. Alternatively, the input synchronization signal may be transferred from a bus to the one or more respective interface subsets of modules 340.

The output O of the output subset of modules may be transferred bit-serially and LSB-first as an input to of one or more respective interface subset of modules 340 associated with one or more subsequent processing units 300. The one or more subsequent processing units may be comprised in a subsequent layer of a computing network. The processing unit 600 may be an MIMD processing unit. The processing unit 600 may be implement using application-specific integrated circuit, ASICs. These ASICs may replace FPGAs, CPUs and GPUs.

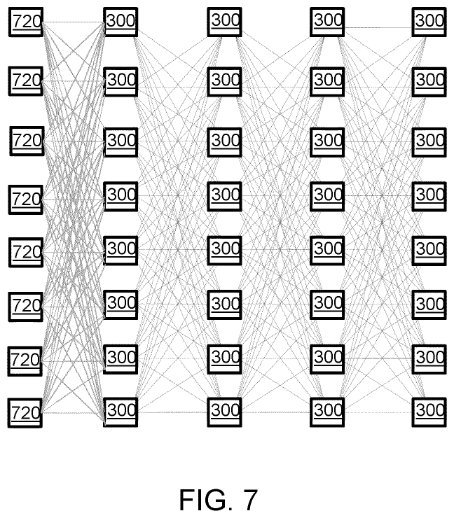

FIG. 7 illustrates a combination of processing units 300 implementing a processing network, according to embodiments. The processing network of FIG. 7 may be used to implement an artificial neural network. The processing network may be used to implement one or more string comparison functions. The processing network shown in FIG. 7 comprises five vertical layers. The leftmost vertical layer of the processing network is a converter layer comprising eight parallel to series converters 720. The first left vertical layer after the leftmost vertical layer comprises eight processing units 300 and may be the input layer of the processing network. The rightmost vertical layer comprises eight processing units 300 and may be the output layer of the processing network. The remaining intermediate two vertical layers may be the hidden layers of the processing network. Each processing unit may correspond to the processing unit 300 according to the embodiments described with respect to FIGS. 3 to 6 above. The output of the output subset of modules of each processing unit in a layer, may be connected to a respective input of a respective interface subset of modules of each processing unit of the respective subsequent layer in the processing network. Each processing unit of a given layer may be configured to synchronize its output, using an input synchronization signal, with the connected inputs of respective interface subsets of respective processing units in a subsequent layer of the processing network. The input synchronisation signal may be transferred from the preceding processing unit, from a preceding parallel to series converter 720 or from a bus. The output of each processing unit in a layer may be LSB-first transferred as an input to the respective interface subsets of respective processing units in a subsequent layer of the processing network. The processing network may be configured to process data continuously or discontinuously. The processing network shown in FIG. 7 may be implement using application-specific integrated circuit, ASICs. These ASICs may replace FPGAs, CPUs and GPUs.

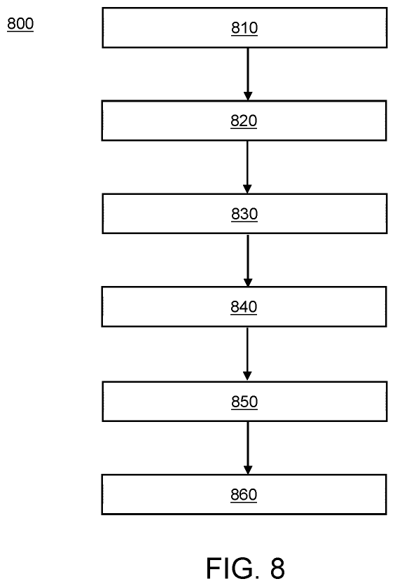

FIG. 8 is a flow diagram illustrating a method 800 for processing the inputs received by a processing unit, according to an embodiment. The processing unit may be an MIMD processing unit. The processing unit enables a real-time MIMD processing of the inputs received at its interface subset of modules. The method begins at step 810 where the interface subset of modules of the processing unit receives a respective total number of inputs and a corresponding number of weights. The respective total number of inputs and the corresponding number of weights may be received bit-serially and LSB-first.

At step 820, each module of the interface subset of modules of the processing unit performs a bit-serial multiplication operation of an input from the respective total number of inputs with a corresponding weight from the number of corresponding weights, to compute the weighted output, while simultaneously repeating step 810.

At step 830, each module of the interface subset of modules simultaneously transfers, with the other modules of the interface subset of modules, the weighted output bit-serially and LSB-first to a corresponding module of the first subset of modules as an input, while simultaneously repeating step 820.

At step 840, the first subset of modules processes the simultaneously transferred inputs and computes corresponding outputs, while simultaneously repeating step 830.

At step 850, the outputs of the first subset of modules are subsequently processed by subsequent subsets of modules to calculate, by the Nth subset of modules, an output, while simultaneously repeating step 840.

At step 860, the output calculated by the Nth subset of modules is received by the output subset of modules that applies one or more activation functions on the calculated output to generate the output of the processing unit, while simultaneously repeating step 850.

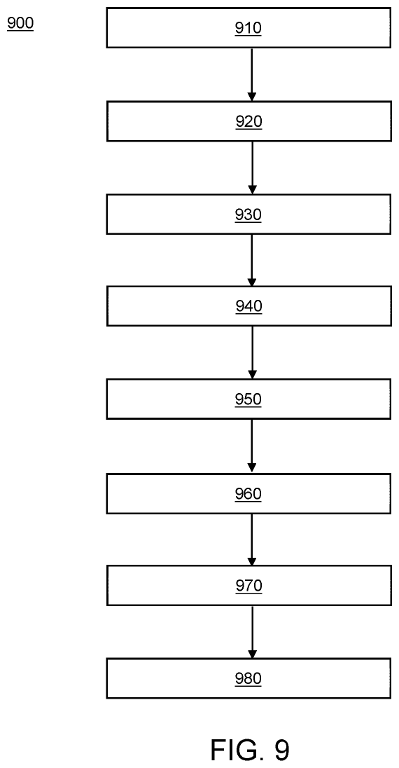

FIG. 9 is a flow diagram illustrating a method 900 for processing the inputs received by a combination of processing units implementing a processing network according to an embodiment such as illustrated by FIG. 7. The processing units combined, enable a real-time MIMD implementation of a processing network. The method begins at step 910 where each interface subset of modules of each processing unit associated with an input layer of a processing network receives a respective total number of inputs from a parallel to series converter and a corresponding number of weights from a control logic.

At step 920, each processing unit associated with the input layer of the processing network processes the total number of inputs to calculate an output, as explained above with reference to FIGS. 3 to 6.

At step 930, the outputs of all processing units of the input layer are simultaneously transferred bit-serially and LSB-first as inputs to the respective interface subsets of each processing unit of the first hidden layer of the processing network, while simultaneously repeating step 920.

At step 940, the processing units of the first hidden layer process the inputs received from the input layer and a corresponding number of weights received from the control logic, and calculate corresponding outputs, while simultaneously repeating step 930.

At step 950, the corresponding outputs of the first hidden layer are simultaneously transferred bit-serially and LSB-first as inputs to the respective interface subsets of each processing unit of the second hidden layer of the processing network, while repeating step 940.

At step 960, the processing units of the second hidden layer process the inputs received from the first hidden layer and a corresponding number of weights received from the control logic, and calculate corresponding outputs, while repeating simultaneously step 950.

At step 970, the corresponding outputs of the second hidden layer are transferred as inputs to the respective interface subsets of each processing unit of the output layer of the processing network, while simultaneously repeating step 960.

At step 980, the processing units of the output layer process the inputs received from the second hidden layer and a corresponding number of weights received from the control logic, and calculate the corresponding outputs of the processing network, while simultaneously repeating step 970.

The particular embodiments and examples described above illustrate but do not limit the invention. It is understandable that other embodiments of the invention may be made and the specific embodiments and examples described above are not exhaustive.

1. A processing unit, comprising:
a plurality of modules, each configured to receive a first number of inputs and to compute an output, the first number of inputs being equal to 2,
the plurality of modules being divided into N subsets of modules, wherein the N subsets of modules are connected in series from a first subset to an Nth subset,
wherein each subset of modules is configured to:
process a respective total number of inputs received by the subset, and
wherein each module of the subsets of modules is configured to:
process the first number of inputs from the respective total number of inputs received by the subset of modules to compute the output of the module in parallel with the other modules of the subset of modules during one clock cycle; and
transfer the output of the module, in parallel with the other modules of the subset of modules, as an input to a respective subsequent subset of modules connected in series,
wherein each module of the subset of modules is configured to transfer, simultaneously with the other modules of the subset of modules, a start bit, to the corresponding module of the respective subsequent subset of modules, wherein the start bits are simultaneously transferred to the corresponding modules in a first time interval preceding a second time interval, wherein the second time interval is the time interval in which the least significant bits, LSBs, of the respective total number of inputs are simultaneously transferred to the corresponding modules of the respective subsequent subset of modules, and wherein a time interval comprises one or more clock cycles.

2. The processing unit of claim 1, wherein the first subset comprises a first number of modules equal to a respective total number of inputs received by the first subset divided by the first number of inputs, the respective total number of inputs received by a subset being an integer multiple of the first number of inputs, wherein each respective subsequent subset of modules comprises a number of modules equal to a number of outputs computed by a subset of modules preceding the subsequent subset of modules divided by the first number of inputs.

3. (canceled)

4. The processing unit of claim 1, the modules of the subsets of modules being configured to transfer the output bit-serially and least significant bit, LSB,-first as an input to a corresponding module of the respective subsequent subset of modules.

5. The processing unit of claim 1, further comprising an interface subset of modules configured to receive a respective total number of inputs and a corresponding number of weights equal to the respective total number of inputs, and to compute weighted outputs,
wherein at least one of:
(a) the interface subset comprises a number of modules equal to the respective total number of inputs received by the interface subset of modules, each module of the interface subset being configured to receive a respective input of the respective total number of inputs and a corresponding weight of the corresponding number of weights, and to compute an output;
(b) each module of the interface subset of modules is configured to transfer the weighted output bit-serially and LSB-first to a corresponding module of the first subset of modules as an input; and
(c) the interface subset is configured to receive the respective total number of inputs bit-serially and LSB-first, and to receive the number of corresponding weights in a bit-parallel format, or bit-serially and LSB-first.

6. (canceled)

7. (canceled)

8. (canceled)

9. The processing unit of claim 5, wherein each module of the interface subset is configured to, simultaneously with the other modules of the interface subset, perform a bit-serial multiplication operation of an input from the respective total number of inputs with a corresponding weight from the number of corresponding weights, to compute the weighted output.

10. The processing unit of claim 1, wherein each subset of modules is further configured to transfer an input synchronization signal to the respective subsequent subset of modules to identify the first time interval in which the start bits are simultaneously transferred to the corresponding modules of the respective subsequent subset of modules.

11. The processing unit of claim 10, wherein the simultaneously transferred start bits are active in the first time interval while the input synchronization signal is active, such that an overflow within the subset of modules is cleared.

12. The processing unit of claim 1, wherein each subset of modules is configured to synchronize the outputs of the subset of modules based on an output synchronization signal, wherein the output synchronization signal is active in a third time interval subsequent to the second time interval, wherein the time at which the third time interval starts is a function of the time taken by a subset of modules to process the respective total number of inputs.

13. The processing unit of claim 1, wherein each module of the subset of modules is configured to process the first number of inputs by performing one or more operations on the first number of inputs, the one or more operations comprising: simultaneously receiving a bit of each input of the first number of inputs, starting with the LSB;
performing at least one of an addition, a subtraction, a multiplication, a division, a logical, and an activation function operation on the received bits to compute the output, and simultaneously receiving, a subsequent bit of each input of the first number of inputs.

14. The processing unit of claim 13, wherein if the performed operation is an addition operation and if the addition operation generates a carry, the carry is added to the subsequent bits, wherein the respective total number of inputs of a subset is equally divided among the modules of the subset, such that the sum of all first numbers of inputs in the subset is equal to the respective total number of inputs of the subset.

15. (canceled)

16. The processing unit of claim 1, further comprising an output subset of modules configured to receive one or more outputs of the subsets of modules and to perform one or more operations on the received one or more outputs to compute an output of the processing unit.

17. The processing unit of claim 16, wherein the one or more operations comprise applying to the received output one or more activation functions.

18. The processing unit of claim 17, wherein the one or more activation functions comprise one or more of binary step, linear, sigmoid, tanh, rectified linear unit, ReLu, leaky ReLU, parameterised ReLU, exponential linear unit, Swish, unit sample, carry, one, modulo, 1/n, and Softmax function.

19. The processing unit of any one of claim 17, wherein the one or more activation functions, are configured to be implemented using fixed look up tables, LUTs, and programmable LUTs.

20. The processing unit of claim 19, further comprising a control logic, wherein the control logic is configured to select one of the fixed LUTs or programmable LUTs to be applied to the received one or more outputs of the subsets of modules.

21. The processing unit of claim 1, wherein each subset of modules is configured to process the respective total number of inputs bit-serial and LSB-first, or partially bit-serial and LSB-first, wherein each processing unit is configured to perform discontinuous processing in a processing network.

22. (canceled)

23. The processing unit of claim 1, wherein each module of the subsets of modules comprises one or more arithmetic and logical circuits, wherein the one or more arithmetic and logical circuits comprise at least one of an adder, a subtractor, a multiplier, an AND, an OR, a NAND, a NOR, a NOT, and an XOR, wherein each module of the subsets of modules is configured to process the first number of inputs by performing, using the one or more arithmetic and logical circuits of the module, one or more operations on the first number of inputs to compute the output.

24. (canceled)

25. A processing method comprising:
receiving, by each subset of a plurality of modules comprised in a processing unit, a respective total number of inputs, wherein the processing unit comprises a plurality of modules divided into N subsets of modules, wherein the subsets of modules are connected in series from a first subset to an Nth subset, wherein each module receives a first number of inputs and to compute an output, and wherein the first number of inputs is equal to 2; and
processing, by each subset of modules comprised in the processing unit, the respective total number of inputs received by each subset, wherein each module of the subset of modules processes the first number of inputs from the respective total number of inputs received by the subset of modules to compute the output of the module in parallel with the other modules of the subset of modules during one clock cycle, and wherein the output of the module is transferred, in parallel with the other modules of the subset of modules, as an input to the respective subsequent subset of modules connected in series,
wherein processing, by each subset of modules comprised in the processing unit, the respective total number of inputs received by each subset comprises transferring, simultaneously with the other modules of the subset of modules, a start bit, to a corresponding module of the respective subsequent subset of modules, wherein the start bits are simultaneously transferred to the corresponding modules in a first time interval preceding a second time interval, wherein the second time interval is the time interval in which the least significant bits, LSBs, of the respective total number of inputs are simultaneously transferred to the corresponding modules of the respective subsequent subset of modules, and wherein a time interval comprises one or more clock cycles.

26. The method of claim 25, wherein at least one of:
(a) the first subset comprises a first number of modules equal to a respective total number of inputs received by the first subset divided by the first number of inputs, wherein the respective total number of inputs received by a subset is a multiple of the first number of inputs,
(b) each subsequent subset of modules comprises a subsequent number of modules equal to a number of outputs computed by a preceding subset of modules divided by the first number of inputs,
(c) the method further comprises transferring, by each module of the subsets of modules. the output bit-serially and LSB-first as an input to a corresponding module of the respective subsequent subset of modules.

27. (canceled)

28. (canceled)

29. The method of claim 25, wherein processing, by each subset of modules comprised in the processing unit, the respective total number of inputs received by each subset, comprises bit-serial and LSB-first processing of the respective total number of inputs, or partial bit-serial and LSB-first processing of the respective total number of inputs.
